(19) United States
(12) Patent Application Publication
(10) Pub. No.: US 2016/0265843 A1
(43) Pub. Date: Sep. 15, 2016

(54) DRYER HAVING A PLURALITY OF STATIONARY CHAMBERS

(71) Applicant: L. B. BOHLE MASCHINEN + VERFAHREN GMBH, Ennigerloh (DE)

(72) Inventors: Lorenz Bohle, Ennigerloh (DE); Carsten Keller, Ennigerlo (DE)

(21) Appl. No.: 15/165,012

(22) Filed: May 26, 2016

Related U.S. Application Data
(63) Continuation of application No. PCT/EP2015/055563, filed on Mar. 17, 2015.

(30) Foreign Application Priority Data
Mar. 18, 2014 (DE) 102014103661.1

(51) Int. Cl. F26B 3/08; F16K 27/06; F16K 11/087; F26B 17/10; F26B 17/18

(52) U.S. Cl. CPC F26B 3/082; F26B 17/10; F26B 17/18; F16K 11/087; F16K 27/067

(57) ABSTRACT

A dryer for drying granulated material for use in pharmaceutical products. The dryer includes a plurality of stationary drying chambers, each having its own feed conduit. A common material removal device receives discharged, dried granules from each of the drying chambers. A changeover valve has a plurality of outlets and provides a path from the supply source of the granulated material to a charge port on each of the drying chambers, so that each drying chamber is charged sequentially. Air ducts provide flows of warmed air. The main air duct provides a main airflow, a relatively large volume of air, to an air inlet in each of the drying chambers. The auxiliary air duct provides a lesser volume of air to the feed conduit of each drying chamber, to aid in moving the granulated material out of the feed conduit and into the drying chamber.

### BACKGROUND INFORMATION

1. Field of the Invention

The invention relates to the field of apparatus for drying granulated material. More particularly, the invention relates to dryers for granulated material used in the pharmaceutical industry.

2. Discussion of the Prior Art

CH 686 343 A5 discloses drying apparatus having multiple drying chambers, whereby the chambers are arranged in a line, one next to the other. EP 2 134 458 B1 discloses similar apparatus for granulating and drying material for pharmaceutical products. The apparatus includes multiple drying chambers and a single feed conduit. The multiple drying chambers, however, are movably mounted around a common rotational axis and the single feed fills the granulated material to be dried into a drying chamber that is positioned at a filling position. Depending on the rotational position of the drying chambers, one drying chamber at a time is positioned at this filling position and is filled via the feed conduit. Apparatus with this configuration of multiple drying chambers is designated as a dryer drum.

After the dryer drum has made a complete circumnavigation, namely, shortly before the first-filled drying chamber is again in the filling position, this first drying chamber, which contains granules that have been dried in the meantime, moves to the discharge position, where the drying chamber is opened and emptied.

U.S. Pat. No. 7,908,765 B2 also discloses granulating and dryer apparatus. Here, the drying chambers are arranged around a central axis, but are stationary. A feed conduit is mounted so as rotate around this central axis, such that granules to be dried are filled into one drying chamber after another. Similarly, a discharge conduit is also mounted so as to rotate around this central axis.

It is desirable that the dryers operate in a continuous process. The individual drying chambers are filled or charged, one after the other and, after the required drying time, accordingly emptied one after the other, whereby amounts of granules are deposited onto a material removal device from one drying chamber after the other at the emptying station. In the end, the material removal device transports dried granulated material to stations downstream in the production line in a virtually continuous manner.

### BRIEF SUMMARY OF THE INVENTION

It is an object of the invention to improve the conventional dryer for granulated material, in a way that enables a virtually continuous drying process. Because the granules are intended for use in pharmaceutical products, it is also an object of the invention to provide a process that ensures that the highest standards of hygiene are maintained and improves the in-feed of material into the dryer.

The dryer according to the invention are connected to a common material removal device. This, too, maintains the closed construction of the dryer and, because of that, no sealing problem arises at the discharge ports of the individual drying chambers, which further reduces the risk of contaminating the area surrounding the dryer with escaping granules.

The dryer according to the invention operates in a virtually continuous manner. Instead of moving the individual drying chambers past the charging and discharge ports, a changeover valve is used to fill or charge the individual drying chambers sequentially. The changeover valve is connected at its input side with the supply of granulated material, for example, with a supply hopper or a similar device, so that granules are constantly available for feeding in at this input side of the valve. The output side of the valve has multiple outlets, i.e., as many outlets as there are drying chambers in the dryer. A feed conduit leads from each outlet to the charge port of a respective one of the drying chambers. The changeover valve allows the various drying chambers to be sequentially connected to the granule supply, so that the granulated material is fed into each selected drying chamber, one after the other.

The dryer according to the invention also provides two different airflows for drying: a main airflow that flows through a main air duct and into the respective drying chamber and an auxiliary airflow that flows through an auxiliary air duct to the feed conduit that leads to the drying chamber that is currently selected for charging with granulated material. The main airflow comprises a greater volume and the auxiliary airflow a lesser volume of drying air. The auxiliary airflow accelerates filling the chamber, i.e., this auxiliary airflow enhances the flow of granules through the feed conduit into the drying chamber. In addition to faster charging of the drying chamber with granules, this airflow also results in a certain pre-drying of the granules within the feed conduit, because the relatively moist granules come into contact with the warmer, filtered drying air upstream of the drying chamber. Thus, the drying process begins even before the granulated material arrives in the drying chamber.

The changeover valve may be constructed as a ball valve and, accordingly, have a sphere-like valve body. This enables a construction of the changeover valve that does not require seals specifically for the valve, resulting in a construction of the dryer according to the invention that is particularly hygienic. This is an advantage, because it avoids the undercuts, protrusions, gaps, or similar interfering contours that are frequently present within a seal arrangement. Such interfering contours frequently result in granules, powder, or similar substances being deposited on and sticking to the seals and then gradually becoming denatured. Such disadvantages are avoided with the construction of the changeover valve as a ball valve.

The outlets on the ball valve may be configured so that repeatedly turning the valve body in one direction releases or opens a respective one of the individual outlets, so that the granulated material is fed sequentially to the various drying chambers. The outlets may be arranged on a common circular path or orbit around the valve body, so that a repeated rotation of the ball valve in the same direction results in every drying chamber being charged with the granulated material, in a repeated sequence, from the first to the last drying chamber and, after the last drying chamber is charged, again beginning with the first drying chamber. In this way, it is not necessary that the changeover valve move back and forth in an oscillating motion, but rather, charging the individual drying chambers is done by having the valve body continuously rotate in an even or smooth motion in one direction. This motion in one direction supports a disturbance-free operation of the valve body and, thus, a trouble-free operation of the changeover valve. The constant rotation of the ball valve may be done with a continuous or a pulsed motion.

The changeover valve has a housing that surrounds the valve body. The surface of the housing and/or the surface of the valve body where the housing makes make contact with the valve body may be made of plastic, thereby eliminating the need to have special seal elements, such as, for example, sealing rings, etc., in order to achieve a seal between the valve body and the housing.

In a particularly advantageous embodiment, the valve body may be made entirely of plastic, so that it has a plastic surface that provides an effective seal where it makes contact with the housing of the changeover valve. The housing of the changeover valve may, for example, be made of metal, so that it is mechanically very robust and at the same time provides excellent friction properties with the valve body that moves inside the housing, thereby ensuring a good seal between the plastic valve body and the housing that is possibly made of metal.

An extruder may be provided as the supply source for the granulated material. The term “extruder” as used herein refers generally to equipment that is used to produce granulated material. This equipment may literally be an extruder, but the term is used here in a figurative sense and it may also refer to equipment that is not an extruder, per se, but instead, a wet granulator, for example, in the form of a double-screw granulator. When the extruder is the supply source, freshly produced granules are transported directly from the extruder to the changeover valve and then from the valve to the respectively selected drying chamber. This completely eliminates the need for a supply hopper. Doing away with the hopper is advantageous in an economic sense, because it eliminates the costs and the necessary space for the hopper, eliminates the need to clean the hopper regularly, and simplifies the set up for the dryer according to the invention, which can now be set up in spaces with smaller dimensions. In other words, eliminating the hopper and delivering the granulated material directly from the extruder to the dryer has a positive effect on the costs of operating the dryer.

The drying chamber may be operated as a fluid bed chamber. The drying air is guided in a conventional manner through a perforated floor up through the drying chamber, so that the granules are in a fluidized bed in the drying chamber and are then intensively and evenly dried in an economically advantageous manner.

The amount of air may be individually controlled for each drying chamber. This individual control may be used particularly to provide differing volumes of main airflow to the same drying chamber during a drying cycle. For example, the volume of the main airflow may be set as high as possible for those drying chambers that are currently being charged with fresh, i.e., relatively moist, granules. The high volume of main airflow enhances the fluidization of the moist granules and prevents them from clumping or baking together on the floor of the drying chamber. In the course of the drying process, the volume of the main airflow may be reduced, namely, when the granules in the drying chamber have been dried to the extent that they are no longer in the danger of baking together.

In a particularly economic embodiment of the dryer according to the invention, the auxiliary air duct does not lead directly to a feed conduit, but rather, to a device that is upstream of the feed conduits. In this way, the number of auxiliary air ducts is reduced from a number that corresponds to the number of drying chambers, each with its own feed conduit, to a single auxiliary air duct that runs only to the upstream device. In other words, only a single auxiliary air duct is required. This embodiment has the additional advantage that the drying air that is introduced as the auxiliary airflow does not come into initial contact with the granulated material in the feed conduit, but instead, at an point upstream of the feed conduit. This is beneficial, because it extends the timespan for pre-drying the granules and the drying is done in a particularly intensive manner.

In a first example of connecting the auxiliary air duct to an upstream device, the duct opens into the changeover valve, so that, as the granules enter the changeover valve, this auxiliary airflow helps transport the granules through the changeover valve and to the respective downstream feed conduits.

In a second example of connecting the auxiliary air duct to an upstream device, the duct is connected directly to the extruder, for example, it opens into the extruder head, i.e., there, where granules produced in the extruded exit the extruder. In this embodiment, the granules produced in the extruder come into contact with drying air, namely, with the auxiliary airflow, while they are still in the extruder. The granules are then guided with the help of the auxiliary airflow into the changeover valve, through the subsequent feed conduit, and then into the selected drying chamber.

The common material removal device onto which all drying chambers discharge the dried granules may be constructed as an airflow conveyor. The dried granules are transported in this embodiment not with help of mechanical conveyor elements, but by means of an airflow. The material removal device is thus free from an entraining device or a conveyor screw, or similar devices, and this provides several advantages. For one, it makes it particularly easy to clean the material removal device, because there are no interfering contours inside the device that make it hard to clean, and for another, the airflow conveyor may be sealed in a simple manner, for example, by a disc valve that represents the outer boundary of the dryer setup. CIP (Clean-in-Place) cleaning may be carried out very simply, with the result that, with little effort, the dryer according to the invention is able to satisfy the required high standards of hygiene. The airflow of the material removal device may also contribute a final portion to the drying process.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a vertical cut through a dryer for granulated material, showing a drying chamber and additional devices that are attached or coupled to the chamber.

FIG. 2 illustrates several drying chambers as shown in FIG. 1, set up next to each other and with a material removal device.

FIG. 3 is a view similar to that of FIG. 2, but with a second material removal device.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

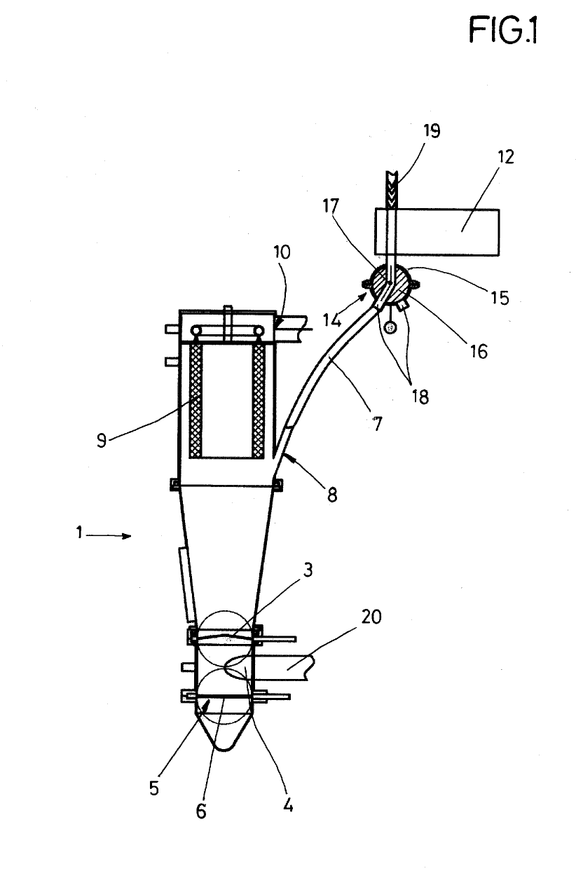

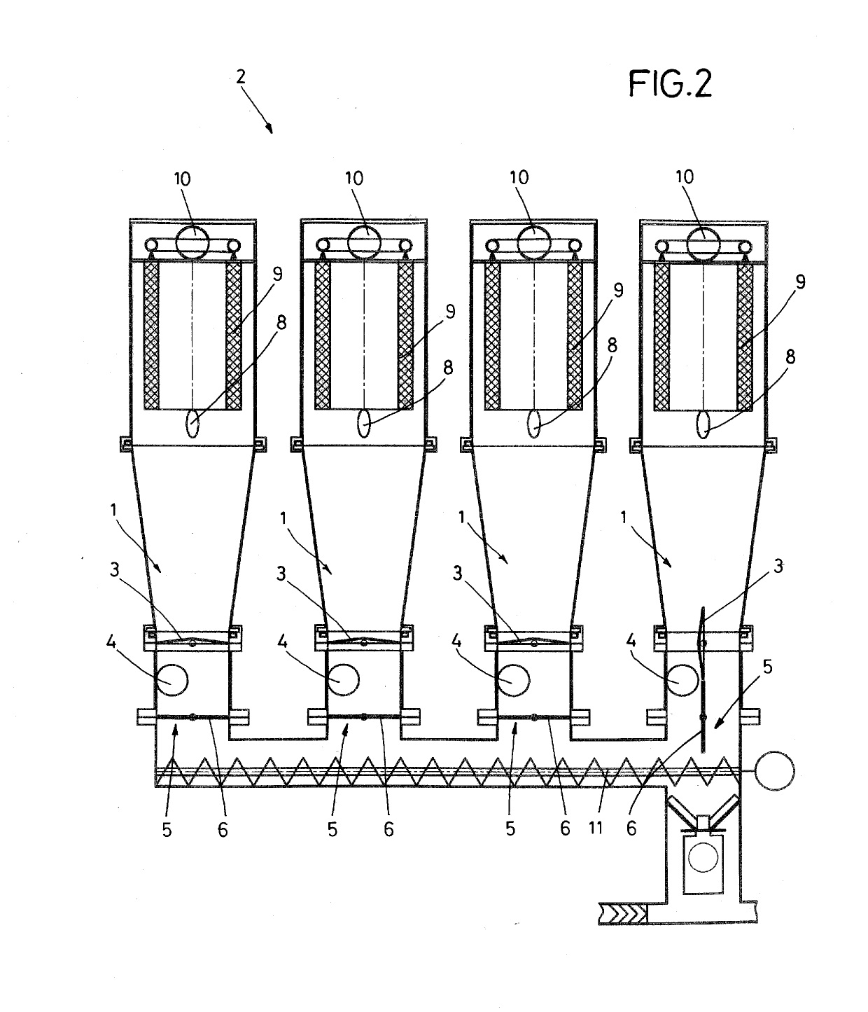

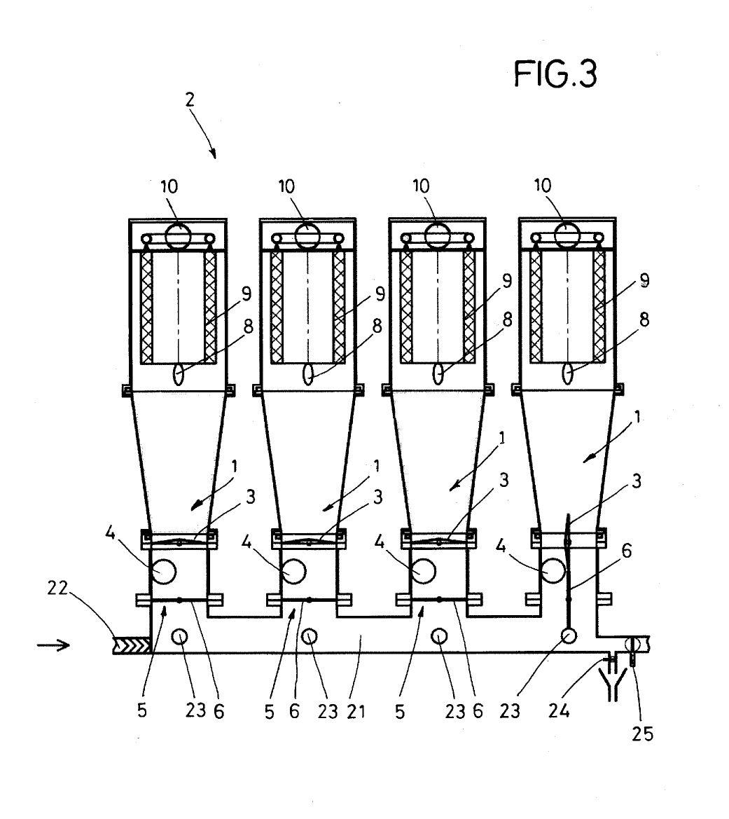

FIG. 1 illustrates a dryer 2 for drying granulated material, the dryer 2 comprising multiple drying chambers 1 that are setup together to form a single dryer 2. FIGS. 2 and 3 illustrate an embodiment of the dryer 2 comprising a configuration of four drying chambers 1.

Each drying chamber 1 has a perforated floor 3 with an air inlet 4 below the floor, allowing filtered and warmed dryer air to enter the drying chamber 1 through the inlet 4 and flow upwards through the drying chamber 1. A discharge port 5 is provided beneath the floor 3 and the air inlet 4 on each drying chamber 1.

Granulated material is fed into the drying chamber 1 by means of a feed conduit 7 that opens into the drying chamber 1 at a charge port 8 that is provided in a wall of the drying chamber 1. A filter 9 is provided in each drying chamber 1 above the feed port 8. The rising drying air passes through the filter 9 into an air exhaust port 10.

The discharge port 5 is selectively opened and closed by means of a discharge flap 6 that is pivotable between a vertical, open position and a horizontal closed position. After the granules have been sufficiently dried, the floor 3 and the discharge flap 6 of the drying chamber 1 are swung from their horizontal closed positions to their vertical open positions, so that the granulated material drops down onto a material removal device that carries the dried material out of the dryer 2. The drying chamber 1 shown on the right in FIGS. 2 and 3 illustrates the open positions and the remaining three drying chambers show the closed positions of the floor 3 and the flap 6.

After being dried, the granules fall through the discharge port 5 onto a material removal device that is common to all drying chambers 1 and which, in the embodiment shown in FIG. 2, is constructed as a screw conveyor 11. The screw conveyor 11 extends beneath all the drying chambers 1, so that the granulated material, which is discharged from all four of the discharge ports 5, sequentially, one port after the other, drops onto the screw conveyor 11 and is transported to the next downstream station of the processing line. The four separate drying chambers 1 are constantly re-charged with granulated material and thus, the dried granulated material is constantly being discharged from one drying chamber or another onto the screw conveyor 11 at the end of each respective drying cycle, so that the dryer 2 operates virtually continuously, i.e., dried granulated material is continuously being made available at the end of the screw conveyor 11 for further processing.

The embodiment of the material removal device shown in FIG. 3 is constructed as an air conveyor 21. The granulated material drops through the discharge port 5 into the material discharge device and, after the discharge flaps 6 are closed, a pulsed blast of air is introduced into the air conveyor via an air port 22, thereby forcing the granulated material through and then out of the air conveyor 21. Measurement points 3, 4, 5 serve to monitor the quality of the product. Each discharged amount of granulated material that exits a drying chamber 1 is monitored, for example, with regard to the degree of dryness of the material. A drain 24 is provided in the travel direction of the air conveyor 21, downstream of the last drying chamber 1, and a disc valve 25 located downstream of the drain 24 defines the end of the dryer 2, i.e., the transition point out of the dryer.

An extruder 12 is schematically illustrated in FIG. 1. The granulated material travels from the extruder 12 through a changeover valve. The changeover valve is constructed as a ball valve 14 and has a metallic housing 15 as well as a ball-shaped, plastic valve body 16. The valve body 16 has a through-bore 17 that is angled, i.e., has a bend in it. Four outlets 18 are provided in the lower half of the housing 15. The outlets 18 are provided in the form of connectors, whereby a feed conduit that leads to one of the four drying chambers 1 is attached to each connector. In FIG. 1, for reasons of simplicity, one feed conduit 7 is shown connected to only one outlet 18.

By turning the valve body 16, the bend in the through-bore 17 provides access to each of the four separate outlets 18, one after the other, so that the ball valve 14 provides a path sequentially between the extruder 12 and each one of the feed conduits 7, thereby refilling each of the four drying chambers 1 with freshly produced granulated material.

The flow of the granulated material from the extruder 12 to the respective drying chamber 1 is supported by an auxiliary airflow of the drying air that flows in an auxiliary air duct 19 that opens into the extruder 12. The freshly produced and still moist granules are supported in their flow behavior by this auxiliary airflow on their travel through the feed conduit 7 into the drying chamber 1.

The feed conduit 7 extends downwardly, so that gravity supports the flow of the granules. The feed conduit 7 is also constructed as a vacuum line, which further supports the travel of the granules. The greater volume of the airflow of the drying air flows as the main airflow through a main air duct 20 to the air inlet 4. The rising air flows through the drying chamber 1 and entrains the auxiliary airflow and the granules therein in the area of the charge port 8, which aids in pulling the charge of granulated material out of the feed line 7 into the drying chamber 1 as quickly as possible.

Similarly, as is described above for the air conveyor device 21 of the material removal device, a pulsed air duct or conveyor may be also be provided on the inlet side, so that, before the ball valve 14 switches from one outlet 18 to another, an auxiliary airflow is pulsed through the auxiliary air duct 19, the through-bore 17 of the ball valve 14, and the feed conduit 7 that is currently in use. This pulsed air blast serves to move the residual material in the respective drying chamber 1 and, thus, to avoid that there any are residues in the lines on the inlet side.

It is understood that the embodiments described herein are merely illustrative of the present invention. Variations in the construction of the dryer apparatus may be contemplated by one skilled in the art without limiting the intended scope of the invention herein disclosed and as defined by the following claims.

What is claimed is:

1. A dryer for drying granulated material for use in pharmaceuticals, the dryer comprising:
a plurality of drying chambers that are stationary mounted, each drying chamber having a perforated floor, an air inlet beneath the floor, an air outlet a distance above the floor, a charge port for charging the drying chamber with moist granulated material, a discharge port for discharging dried granulated material;
a plurality of feed conduits corresponding in number to the plurality of drying chambers, each feed conduit feeding the moist granulated material from a supply source of the granulated material to a respective one of the plurality of drying chambers;
a changeover valve having a valve inlet side that is connected with the supply source of the moist granulated material and having a valve outlet side with a plurality of outlets corresponding in number to the number of drying chambers;
air ducts that include a main air duct that provides a main volume of air to the air inlet of each of the drying chambers and an auxiliary air duct that provides an auxiliary volume of air to each of the feed conduits, wherein the auxiliary volume of air is a lesser volume than the main volume of air; and
a material removal device that receives the dried granulated material from the plurality of drying chambers;
wherein the changeover valve is switchable so as to release a flow of the moist granulated material from the supply source through a respective one of the plurality of outlets and to a corresponding respective one of the plurality of drying chambers.

2. The dryer of claim 1, wherein the changeover valve is constructed as a ball valve with a spherical valve body.

3. The dryer of claim 2, wherein the valve body is rotated in one direction and wherein the plurality of outlets are arranged on the valve body such, that, during rotation of the valve body, the moist granulated material is sequentially delivered to each one of the plurality of drying chambers.

4. The dryer of claim 2, wherein the changeover valve has a housing and wherein a surface of the valve body that makes contact with a surface of the housing is made of plastic.

5. The dryer of claim 2, wherein the changeover valve has a housing and wherein a surface of the housing that makes contact with the valve body is made of plastic.

6. The dryer of claim 2, wherein the valve body is made of plastic.

7. The dryer of claim 1, further comprising an extruder that serves as the supply source of the moist granulated material.

8. The dryer of claim 1 further comprising an upstream device that is upstream of and coupled with the plurality of feed conduits, wherein the auxiliary air duct feeds the auxiliary volume of air to the upstream device.

9. The dryer of claim 8, wherein the auxiliary air duct feeds a second lesser volume of dryer air to the extruder.

10. The dryer of claim 1, wherein the material removal device is constructed as an air conveyor.
